(19) United States
(12) Patent Application Publication
(10) Pub. No.: US 2024/0317644 A1
(43) Pub. Date: Sep. 26, 2024

(54) Polymer Concrete with Plastic Aggregate and Fines

(71) Applicant: Bratislava Asset Protection Trust, Suite #400, UT (US)

(72) Inventor: Richard P. Giles, Park City, UT (US)

(21) Appl. No.: 18/601,883

(22) Filed: Mar. 11, 2024

Related U.S. Application Data
(63) Continuation of application No. 17/003,095, filed on Aug. 26, 2020, now abandoned.
(60) Provisional application No. 62/892,496, filed on Aug. 27, 2019.

(51) Int. Cl. C04B 18/30; C04B 18/02; C04B 18/04; C04B 18/08; C04B 26/00; C04B 26/14; C04B 41/48; C04B 103/14; C04B 111/00; C04B 111/72; E01C 11/00

(52) U.S. Cl. CPC C04B 18/30; C04B 18/022; C04B 18/0427; C04B 18/08; C04B 26/006; C04B 26/14; C04B 41/4853; E01C 11/005; C04B 2103/14; C04B 2111/00663; C04B 2111/0075; C04B 2111/72; Y02W 30/91

(57) ABSTRACT

A composition that may include a resin, plastic aggregate, plastic fines, and optionally fly ash. The plastic aggregates and plastic fines may be formed from recycled plastic. The composition may be utilized to repair damaged surfaces, including damages concrete surfaces. The composition may further be used in pre-formed structures. The pre-formed structures may include panels that are assembled to form an upright enclosure, such as a shelter.

### CROSS-REFERENCE TO RELATED APPLICATIONS

This application is a continuation of U.S. patent application Ser. No. 17/003,095 filed on Aug. 26, 2020, which claims the benefit of U.S. Provisional Application No. 62/892,496 filed on Aug. 27, 2019, which applications are hereby incorporated by reference in their entirety.

### STATEMENT REGARDING FEDERALLY SPONSORED RESEARCH OR DEVELOPMENT

Not Applicable.

### BACKGROUND OF THE INVENTION

### 1. The Field of the Invention

The present invention relates generally to roadways, and more particularly, but not necessarily entirely, to the repair and maintenance of roadways.

### 2. Description of Related Art

The repair and maintenance of roadways is a costly and time-consuming endeavor. Pothole repair is particularly vexing as repairs tend to fail within a relatively short period of time making additional repairs necessary. Typical pothole repair includes the placement of a sufficient amount of a fill material into the pothole. For example, in the case of a pothole formed in an asphalt roadway, replacement asphalt-type material may be used to repair the pothole. In the case of a pothole formed in a concrete roadway, replacement concrete-type material may be used to repair the pothole.

As mentioned, pothole repairs tend to fail in relatively short amounts of time. Repair failure may be due to several reasons, the primary of which is that the repair material may not properly bond to the adjacent cured roadway. In some instances, the interface between the cured roadway adjacent the pothole and the repair material is porous such that moisture seeps into the repaired pothole. The moisture may lead to further erosion and damage in areas that have a freeze-thaw cycle. Further, automobile traffic may cause the formation of cracks at the repair-roadway interface that spread deep into the fill material. Such cracks may eventually lead to fragmenting of the fill material. It would be an advantage over the prior art to provide an improved repair method and system for repairing a pothole in a roadway.

The prior art is thus characterized by several disadvantages that are addressed by the present invention. The present invention minimizes, and in some respects eliminates, the above-mentioned failures, and other problems, by utilizing the methods and structural features described herein. The features and advantages of the invention will be set forth in the description which follows, and in part will be apparent from the description, or may be learned by the practice of the invention without undue experimentation. The features and advantages of the invention may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 depicts a pothole in a roadway identified for repair according to an embodiment of the present disclosure;

FIG. 2 depicts the pothole in FIG. 1 with the debris removed;

FIG. 3 depicts the pothole in FIG. 1 with the boreholes formed in the interior surface;

FIG. 4 depicts the pothole in FIG. 1 with the boreholes and pothole filled with a fill material;

FIG. 5 depicts the pothole in FIG. 1 with the fill material and a friction enhancing material;

FIG. 6 is a flow chart of a process for repairing a pothole in a roadway according to an embodiment of the present disclosure;

FIG. 7 depicts the deformability of the binding agent used in roadway repairs according to an embodiment of the present disclosure

FIGS. 8A-8C depict a mixer for a binding agent and an aggregate according to an embodiment of the present disclosure;

FIG. 9 shows a metal cover installed over an access tunnel and having a damaged concrete apron;

FIG. 10 shows the concrete apron in FIG. 9 after repairs according to an embodiment of the present disclosure;

FIG. 11 shows a damaged pedestrian ramp;

FIG. 12 shows the pedestrian ramp in FIG. 11 after repairs according to an embodiment of the present disclosure;

FIG. 13 depicts a damaged concrete water trough formed in a roadway;

FIG. 14 depicts the concrete water trough in FIG. 13 after repairs according to an embodiment of the present disclosure;

FIG. 15 shows a metal cover manhole cover installed over an access tunnel and having a damaged concrete apron;

FIG. 16 shows the concrete apron in FIG. 15 after repairs according to an embodiment of the present disclosure;

FIG. 17 depicts a metal grate in a roadway having a damaged concrete apron;

FIG. 18 shows the concrete apron in FIG. 17 after repairs according to an embodiment of the present disclosure;

FIG. 19 depicts a damaged surface;

FIG. 20 depicts the surface in FIG. 19 after repairs according to an embodiment of the present disclosure;

FIG. 21 depicts a process for preparing a damaged surface for repair according to an embodiment of the present disclosure;

FIG. 22 depicts a mixer for use in mixing resin and aggregate utilized in surface repair according to an embodiment of the present disclosure;

FIG. 23 depicts a process for finishing a repair to a damaged surface according to an embodiment of the present disclosure;

FIG. 24 depicts a manhole assembly having a damaged inner surface; and

FIG. 25 depicts the manhole assembly of FIG. 24 after repairs according to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. As used herein, the terms “comprising,” “including,” “containing,” “having,” “characterized by,” and grammatical equivalents thereof are inclusive or open-ended terms that do not exclude additional, unrecited elements or method steps. As used herein, the term “about” means within 20% higher or lower than the stated value.

As used herein, the term “roadway” may refer to surfaces formed from asphalt or concrete and includes asphalt and concrete surfaces intended for all types of wheeled vehicles, including automobiles, bicycles, airplanes and the like. The term “roadway” may also refer to footpaths, trails and other surfaces intended for pedestrian traffic. The term “roadway” may include roads, highways, freeways, bridges, pathways, trails, parking lots, runways, sidewalks and the like.

The present disclosure is directed to a novel system and method for improved roadway repair. The present disclosure may be particularly suited for repairing damaged portions of roadways. As used herein, the term “damaged portion,” when used in reference to a roadway, may include potholes, cracks, voids, partially broken areas, scrapes, worn portions, and any other type of damage that occurs to roadways. The damaged portion may be caused by traffic and weather.

In an embodiment, the present disclosure provides a fill material with improved durability and life as compared to previous repair materials and methods.

In an embodiment, a method for repair of a roadway comprises clearing the damaged portion of loose debris. Boreholes are then formed in the interior surface of the damaged portion. One or more of the boreholes may undercut the non-damaged portion of the roadway. The boreholes may have a diameter between one-half inch and three inches. A depth of the boreholes may range from about six inches to three feet. The boreholes may be formed using a handheld or machine mounted drill having an auger type bit. The number of boreholes formed in the pothole may depend on the size of the pothole. In an embodiment, the number of boreholes may range from one to twenty. In an embodiment, the number of boreholes is two.

Once the boreholes are formed, a fill material may be placed into the damaged portion. The fill material may have a consistency such that it travels to the bottom of the boreholes. The fill material may be even with a top surface of a surface layer of the roadway. In an embodiment, the fill material may comprise a resin. In an embodiment, the fill material may comprise a resin and aggregate mixture. Suitable resins may include polymer-based resins. Once the fill material has been placed into the damaged portion, a friction enhancing topcoat may be installed onto the top of the fill material. In an embodiment, a pigment may be added to the fill material to match the color of the roadway.

Aspects of the present disclosure contemplate using a plastic aggregate in the fill material as well as plastic fines.

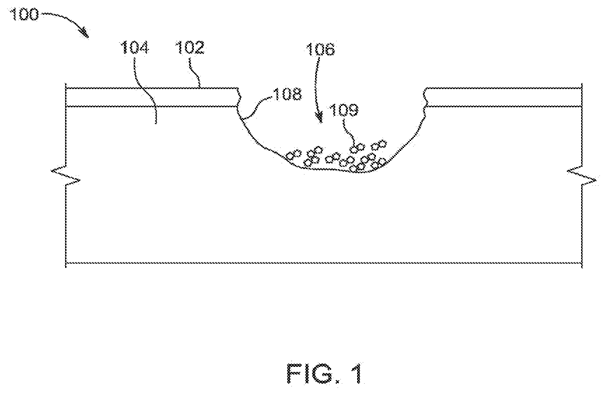

Referring now to FIG. 1, there is depicted a roadway 100 according to an embodiment of the present disclosure. The roadway 100 may be formed of any suitable material. The roadway 100 may include a surface layer 102 formed on a base material 104 as is known to those of ordinary skill. The surface layer 102 may be formed of any suitable material, including, but not limited to, asphalt or concrete. The base material 104 may be formed of aggregate or some other crushed material, such as crushed stone.

A damaged portion 106 may be formed in the roadway 100. The damaged portion 106 may be caused by several factors, including the wear and tear of traffic as well as seasonal freeze-thaw cycles. The damaged portion 106 may take any shape or form, including cracks or other types of damage in the roadway 100. The damaged portion 106 may have an interior surface 108 that defines a cavity or void that extends below the surface layer 102 and into the base material 104. Loose debris 109 may be present in the bottom of the damaged portion 106. The loose debris 109 may include fragmented pieces of the surface layer 102.

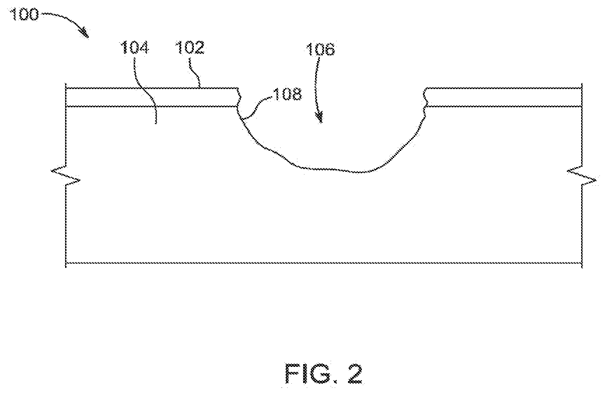

As shown in FIG. 2, where like reference numerals depict like components, the first step in patching the damaged portion 106 is to remove the loose debris to expose the interior surface 108. This may be done using handheld or powered tools, including shovels.

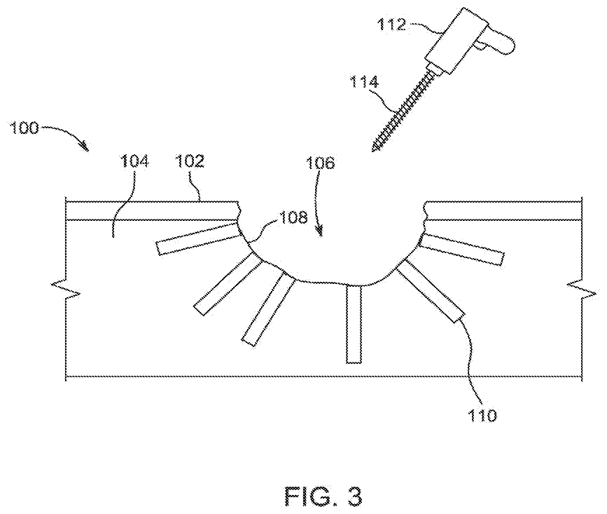

As shown in FIG. 3, where like reference numerals depict like components, the next step in patching the damaged portion 106 is to form at least one borehole 110 in the interior surface 108. In an embodiment, the at least one borehole 110 may be formed using a powered tool, such as a drill 112 having a bit 114. In an embodiment, the drill 112 may be one of electric and hydraulic. In an embodiment, the drill 112 may be handheld or mounted to an arm of a machine.

In an embodiment, the diameter of the bit 114 is between one-half inch and three inches. In an embodiment, the diameter of the bit 114 is about one inch. In an embodiment, a length of the cutting surface of the bit 114 is between six inches to three feet. In an embodiment, a length of the cutting surface of the bit 114 may be about one foot, or between ten inches and fourteen inches. In an embodiment, a length of the cutting surface of the bit 114 may be about two feet.

The at least one borehole 110 may have a diameter between one-half inch and three inches. In an embodiment, the diameter of the at least one borehole 110 is one inch. A depth of the at least one borehole 110 may range from about six inches to three feet. In an embodiment, the depth of the at least one borehole 110 may be about one foot, or between ten inches and fourteen inches. In an embodiment, the depth of the at least one borehole 110 may be about two feet.

The number of boreholes 110 formed in the damaged portion 106 may depend on the size void formed by the damaged portion 106. In an embodiment, the number of boreholes 110 may range from about one to twenty, or two boreholes. In an embodiment, some of the at least one borehole 110 may undercut the surface layer 102. In an embodiment, the boreholes 110 may extend into the base material 104.

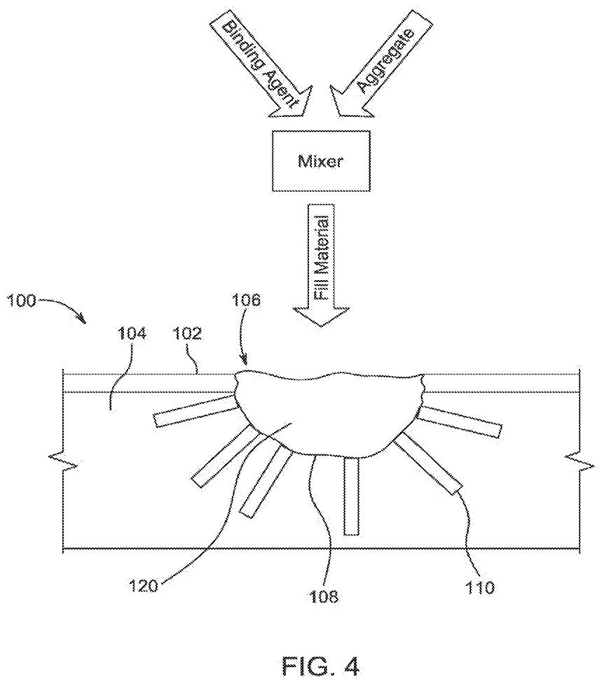

As shown in FIG. 4, the next step for repairing the damaged portion 106 is to install a fill material 120. The fill material 120 may have a consistency such that it flows into the at least one borehole 110. The fill material 120 may comprise a mixture of a binding agent and an aggregate. In an embodiment, the binding agent is a resin, such as a polymer resin. In an embodiment, the resin may be a two-part resin that includes the use of a curing agent.

In an embodiment, the aggregate is a plastic aggregate. Plastic fines and optionally cenosphere may also be added to the resin along with the plastic aggregate.

The resin, plastic aggregate, and plastic fines and optionally cenosphere may be mixed in a mixer 115 having a mixing container, drum or tub. In an embodiment, the mixer 115 may include a combustion engine powered by a fuel that mixes the binding agent and aggregate and fines. In an embodiment, the mixer 115 may include an electric motor.

In an embodiment, a carbon fiber material may be added to the fill material 120 during the mixing process to provide additional strength to the repair. In an embodiment, shredded carbon fiber material may be added to the fill material 120.

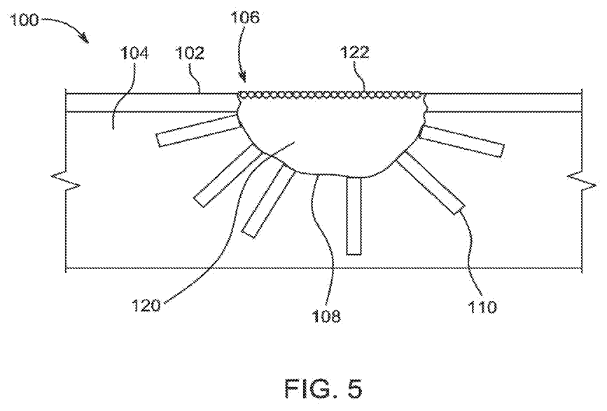

As shown in FIG. 4, the fill material 120 is placed into the damaged portion 106 until it is about even with the top of the surface layer 102. As shown in FIG. 5, a friction enhancing material 122 may be placed or sprinkled onto the top of the fill material 120. The friction enhancing material 122 may comprise a crushed material, such as crushed stone.

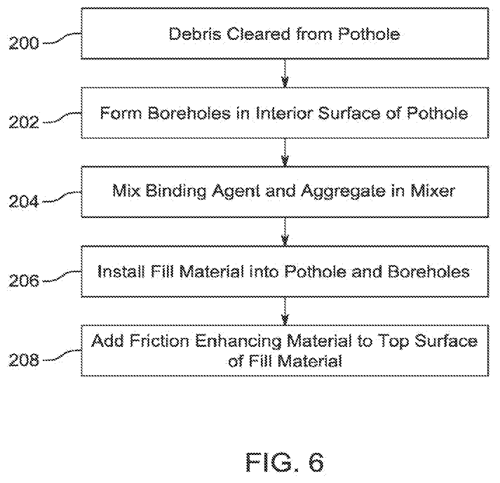

Referring now to FIG. 6, a method of repairing a damaged portion is disclosed. At step 200, debris is cleared from the damaged portion in order to expose an interior surface of the damaged portion. At step 202, at least one borehole is formed in the interior surface of the damaged portion. The at least one borehole may have a diameter between about one half inch and three inches. In an embodiment, the at least one borehole may have a diameter of about one inch. It will be appreciated that the at least one borehole may have any diameter. The at least one borehole may be formed by a bit mounted on a drill. In an embodiment, the depth of the at least one borehole may be about two feet. It will be appreciated that at least one borehole may have any depth.

At step 204, a binding agent and plastic aggregate and plastic fines and optionally cenosphere are added to a mixer. The binding agent and aggregate and fines are mixed together to form a fill material. In an embodiment, the fill material comprises a binding agent and an aggregate and fines mixture that are combined in the mixing container on site. In an embodiment, the binding agent and the aggregate and fines mixture are pre-mixed offsite and transported to the site of the damaged portion.

In an embodiment, the binding agent is a resin, such as is a polymer resin. In an embodiment, the binding agent is an epoxy resin. In an embodiment, the aggregate is a plastic aggregate and the fines are plastic fines In an embodiment, carbon fiber, such as shredded carbon fiber, is mixed into the fill material. Pigment may also be added to the fill material to match the color of the roadway.

In an embodiment, the fill material may be mixed by an auger mixer. The aggregate may be fed from a hopper into the auger mixer. The binding agent, such as a thermosetting resin, may be injected into the auger mixer. A curing agent or hardener (polymerization catalyst) may be injected into the auger mixer.

At step 206, the fill material is installed into the damaged portion and the at least one borehole. In an embodiment, the fill material may be poured or pumped from the mixer. A top surface of the fill material may be about even with the top of the roadway. At step 208, a friction enhancing material is placed onto the top surface of the fill material. It will be appreciated that the friction enhancing material may include a granular material, such as crushed stone, sand, or any other substance.

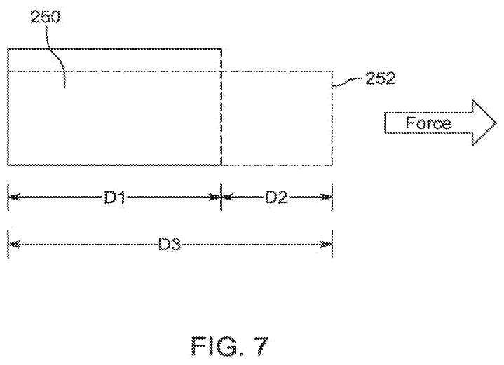

Referring now to FIG. 7, according to an embodiment of the present disclosure, a cured binding agent 250 suitable for use in the repair as described above may be deformable under tension, either plastically or elastically. It will be appreciated that the deformability of the cured binding agent 250 improves the life of the repair, especially when subject to the impact forces of vehicle traffic. The binding agent 250 may be deformed by a tension force to a new shape shown by the dashed line 252. As shown, length DI represents the original length of the binding agent 250, length D3 represents the stretched length of the binding agent 250, and D2 is the difference between D3 and D2. When the tension force is removed, the binding agent 250 may or may not return to its original shape due to its elasticity. In some cases, the stretched binding agent will not return to its original shape as it is plastically deformable. In an embodiment, the binding agent 250 is deformable under tension to a percentage of its original length.

In an embodiment, a “percentage of deformability” is a property of the cured binding agent 250 and is defined by Equation 1, below:

$$\frac{{D}_{3} - {D}_{1}}{{D}_{1}}$$

Where D1 is an original length of the cured binding agent and D3 is a stretched length of the cured binding agent. The percentage of deformability defined by Equation 1 represents the amount of deformation under which the binding agent 250 undergoes without failing. As used herein, the term “failure” may mean the cured binding agent 250 breaks into two pieces. For example, if the binding agent 250 is deformable under a tension force from an original length of 4 units (D1) to a length of 6 units (D3) without failure, the percentage of deformability is at least 50%. By way of another example, if the binding agent 250 is deformable under a tension force from an original length of 4 units (D1) to a length of 5 units (D3) without failure, the percentage of deformability is at least 25%.

In an embodiment, the percentage of deformability of the binding agent 250 suitable for roadway repair as described herein is at least 15%. In an embodiment, the percentage of deformability of the binding agent 250 suitable for roadway repair as described herein is at least 20%. In an embodiment, the percentage of deformability of the binding agent 250 suitable for roadway repair as described herein is at least 25%. In an embodiment, the percentage of deformability of the binding agent 250 suitable for roadway repair as described herein is at least 30%. In an embodiment, the percentage of deformability of the binding agent 250 suitable for roadway repair as described herein is at least 35%. In an embodiment, the percentage of deformability of the binding agent 250 suitable for roadway repair as described herein is at least 40%. In an embodiment, the percentage of deformability of the binding agent 250 suitable for roadway repair as described herein is at least 45%. In an embodiment, the percentage of deformability of the binding agent 250 suitable for roadway repair as described herein is at least 50%. In an embodiment, the percentage of deformability is between 15% and 50%. It will be appreciated that the binding agent 250 may be a polymer resin suitable for use in roadway repair as described above.

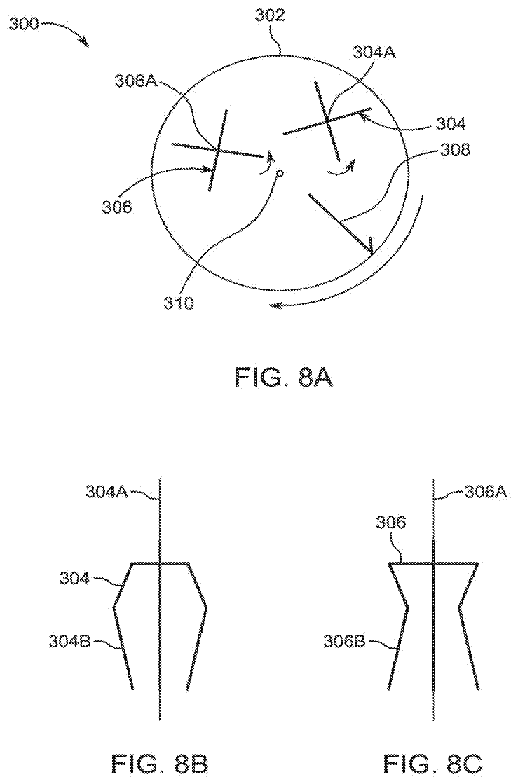

Referring now to FIGS. 8A, 8B and 8C, there is depicted an exemplary embodiment of a mixer 300 suitable for use with the present disclosure. The mixer 300 may be utilized to mix a binding agent and aggregate as disclosed herein. The mixer 300 may include a mixing tub 302. The mixer 300 may further include a first mixing blade assembly 304 and a second mixing blade assembly 306. The mixer 300 may further include a scraper 308.

The first mixing blade assembly 304 may rotate about a first axis 304A and the second mixing blade assembly 306 may rotate about a third axis 306A. In addition, the first mixing blade assembly 304 and the second mixing blade assembly 306 and the scraper may rotate about a second axis 310. It will be appreciated that the first mixing blade assembly 304 may include a plurality of blades 304B and the second mixing blade assembly 306 may include a plurality of blades 306B.

It will be appreciated that the use of the boreholes in the interior surface of the damaged portions, as described herein, provide a more secure repair that is able to withstand traffic as well as inclement weather. In particular, the fill material in the boreholes provides an anchor for the main portion of the pothole repair. The present disclosure may be utilized with both asphalt and concrete roadways.

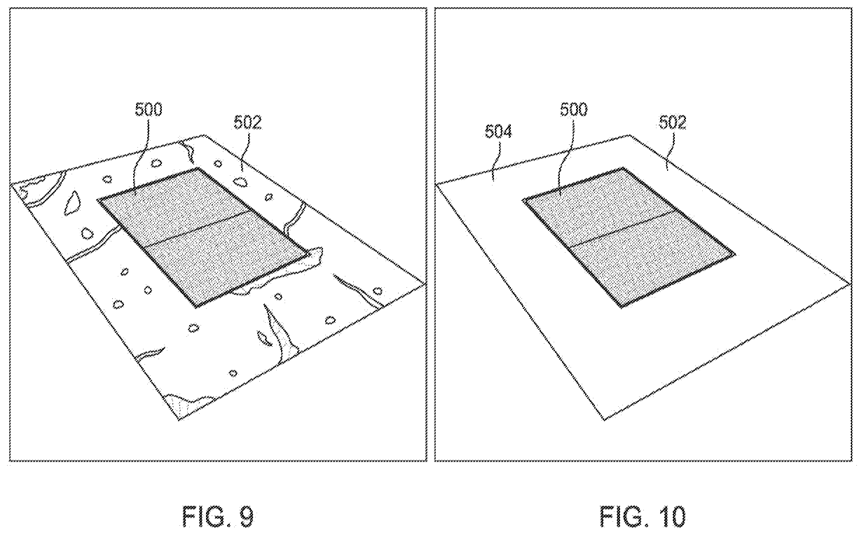

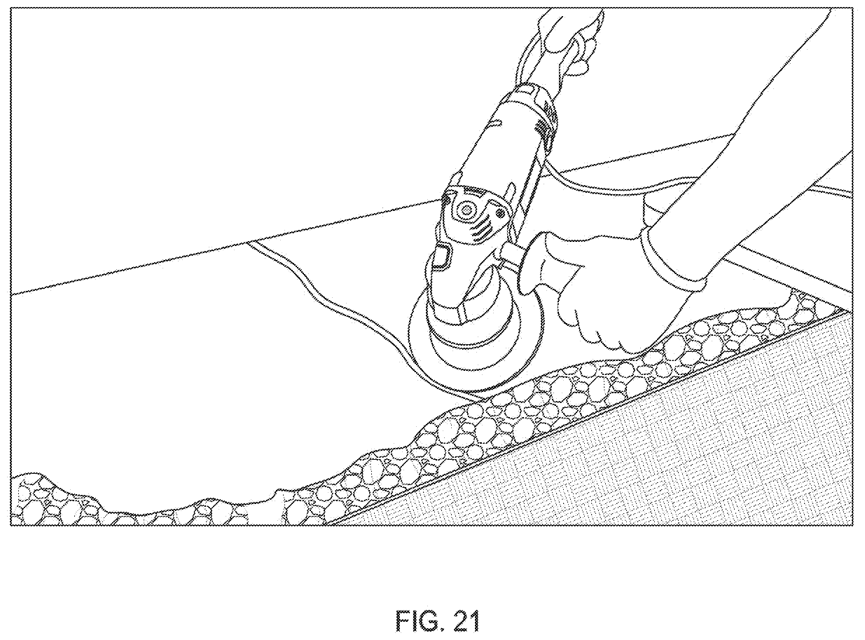

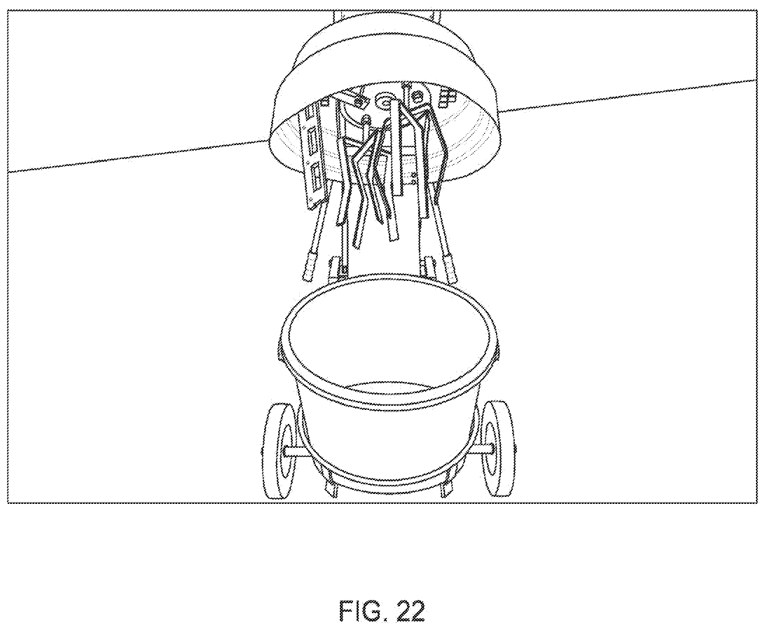

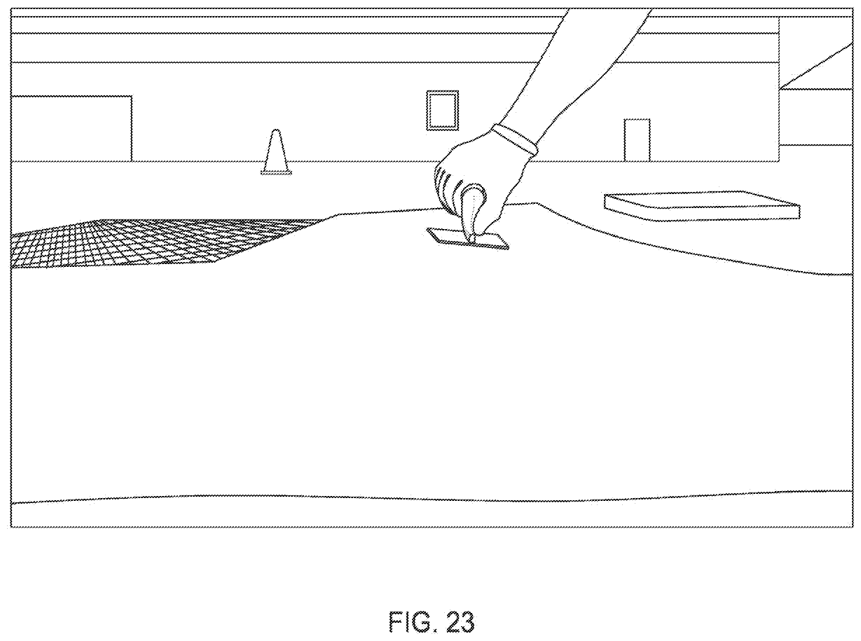

Referring now to FIG. 9, there is depicted a metal cover 500 installed over a utility access tunnel. Surrounding the cover 500 is a concrete apron 502. As can be seen, the apron 502 is damaged and includes cracks, pits and voids. A process of repairing the apron 502 is as follows. First, the apron 502 is cleared of debris. Next, as shown in FIG. 21, a grinder is used to remove rough edges and loose edges on the apron 502. Next, a protective overlay and composite material 504 is installed onto the apron 502 to effectuate the repair. In an embodiment, the protective overlay material 504 is mixed in a mixer as shown in FIG. 22 and then placed onto the damaged surface of the apron 502. The material 504 is then finished by using a hand trowel as shown in FIG. 23. The repaired apron 502 is shown in FIG. 10.

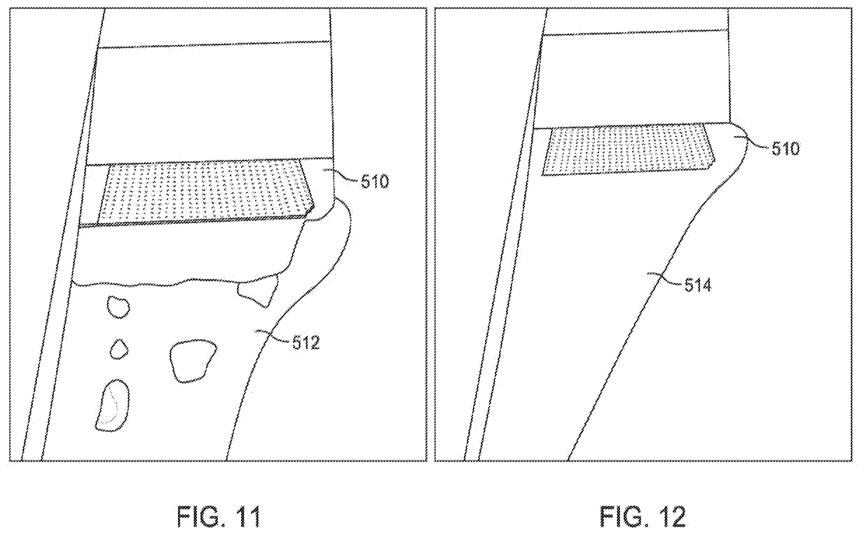

Referring now to FIG. 11, there is depicted a concrete pedestrian ramp 510 having a damaged surface 512. The damage to the surface 512 includes cracks, pits and voids. A process of repairing the surface 512 is as follows. First, the surface 512 is cleared of debris. Next, as shown in FIG. 21, a grinder is used to remove rough edges and loose edges on the surface 512. Next, a protective overlay and composite material 514 is installed onto the surface 512 to effectuate the repair. In an embodiment, the protective overlay material 514 is mixed in a mixer as shown in FIG. 22 and then placed onto the damaged surface of the surface 512. The material 514 is then finished by using a hand trowel as shown in FIG. 23. The repaired ramp 510 is shown in FIG. 12.

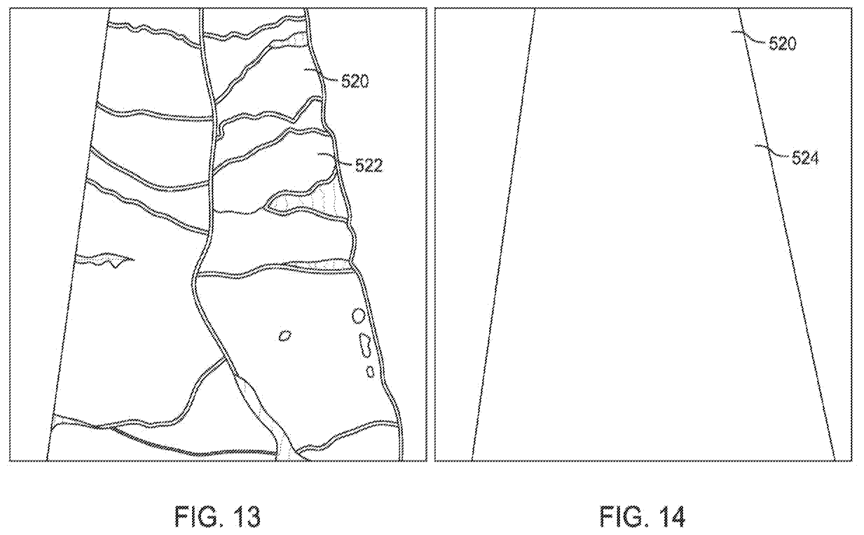

Referring now to FIG. 13, there is depicted a concrete trough 520 having a damaged surface 522. The damage to the surface 522 includes cracks, pits and voids. A process of repairing the surface 522 is as follows. First, the surface 522 is cleared of debris. Next, as shown in FIG. 21, a grinder is used to remove rough edges and loose edges on the surface 522. Next, a protective overlay and composite material 524 is installed onto the surface 522 to effectuate the repair. In an embodiment, the protective overlay material 524 is mixed in a mixer as shown in FIG. 22 and then placed onto the damaged surface of the surface 522. The material 524 is then finished by using a hand trowel as shown in FIG. 23. The repaired trough 520 is shown in FIG. 14.

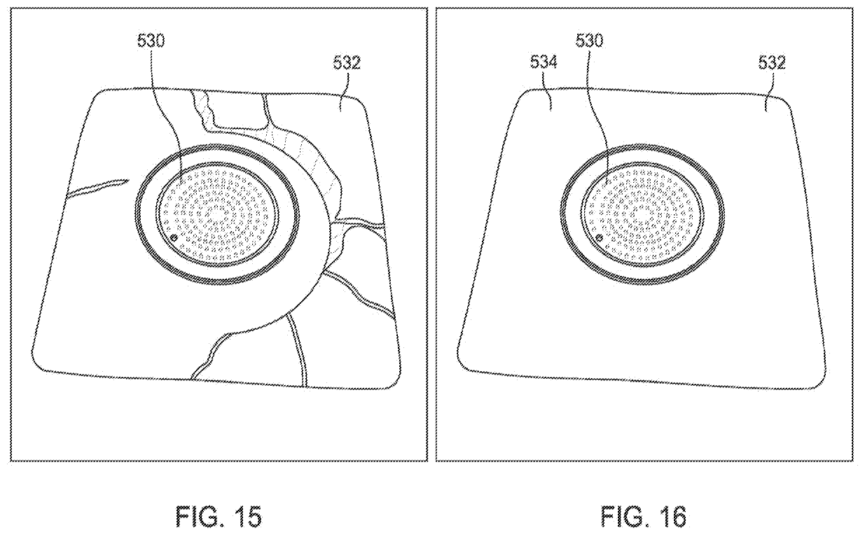

Referring now to FIG. 15, there is depicted a manhole cover 530 installed over a utility access tunnel. Surrounding the cover 530 is a concrete apron 532. As can be seen, the apron 532 is damaged and includes cracks, pits and voids. A process of repairing the apron 532 is as follows. First, the apron 532 is cleared of debris. Next, as shown in FIG. 21, a grinder is used to remove rough edges and loose edges on the apron 532. Next, a protective overlay and composite material 534 is installed onto the apron 532 to effectuate the repair. In an embodiment, the protective overlay material 534 is mixed in a mixer as shown in FIG. 22 and then placed onto the damaged surface of the apron 532. The material 534 is then finished by using a hand trowel as shown in FIG. 23. The repaired apron 532 is shown in FIG. 16.

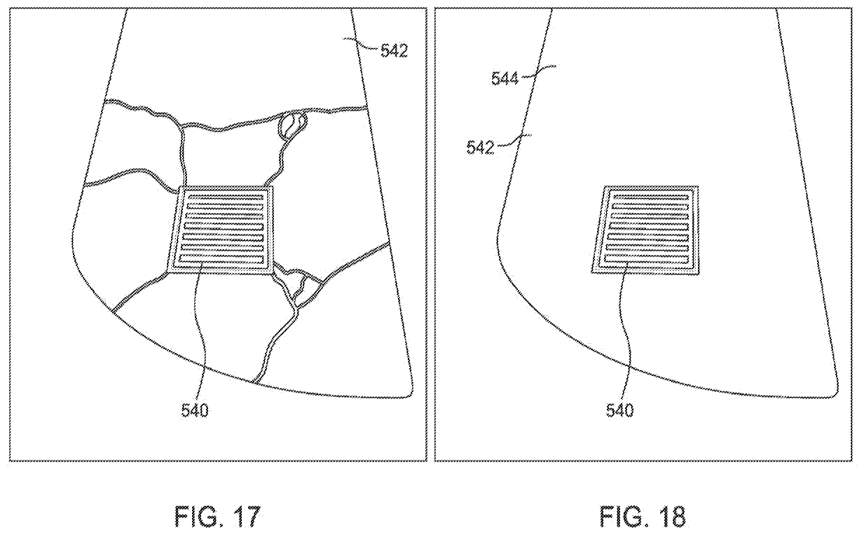

Referring now to FIG. 17, there is depicted a metal grate 540 installed over a drain pipe. Surrounding the grate 540 is a concrete trough 542. As can be seen, the trough 542 is damaged and includes cracks, pits and voids. A process of repairing the trough 542 is as follows. First, the trough 542 is cleared of debris. Next, as shown in FIG. 21, a grinder is used to remove rough edges and loose edges on the trough 542. Next, a protective overlay material 544 is installed onto the trough 542 to effectuate the repair. In an embodiment, the protective overlay material 544 is mixed in a mixer as shown in FIG. 22 and then placed onto the damaged surface of the trough 542. The material 544 is then finished by using a hand trowel as shown in FIG. 23. The repaired trough 542 is shown in FIG. 18.

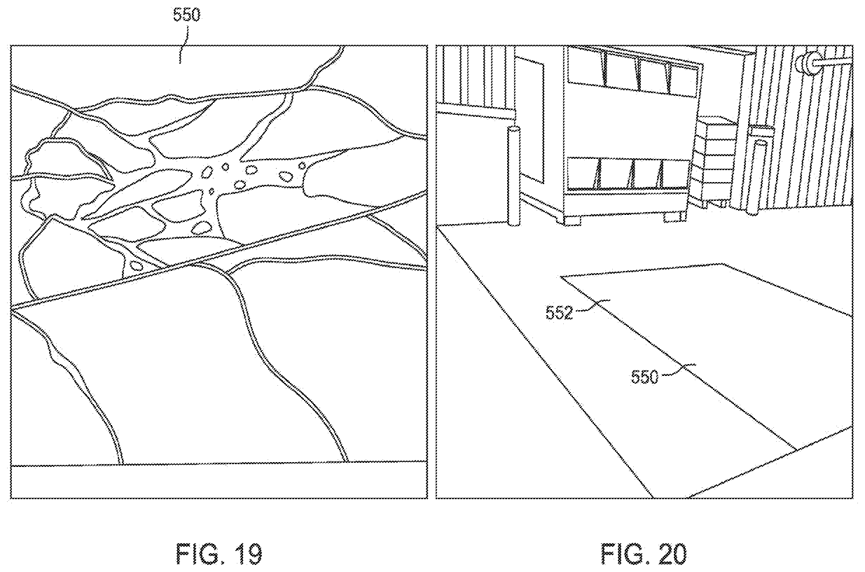

Referring now to FIG. 19, there is depicted a concrete pad 550. As can be seen, the pad 550 is damaged and includes cracks, pits and voids. A process of repairing the pad 550 is as follows. First, the pad 550 is cleared of debris. Next, as shown in FIG. 21, a grinder is used to remove rough edges and loose edges on the pad 550. Next, a protective overlay and composite material 552 is installed onto the pad 550 to effectuate the repair. In an embodiment, the protective overlay material 552 is mixed in a mixer as shown in FIG. 22 and then placed onto the damaged surface of the pad 550. The material 552 is then finished by using a hand trowel as shown in FIG. 23. The repaired pad 550 is shown in FIG. 20.

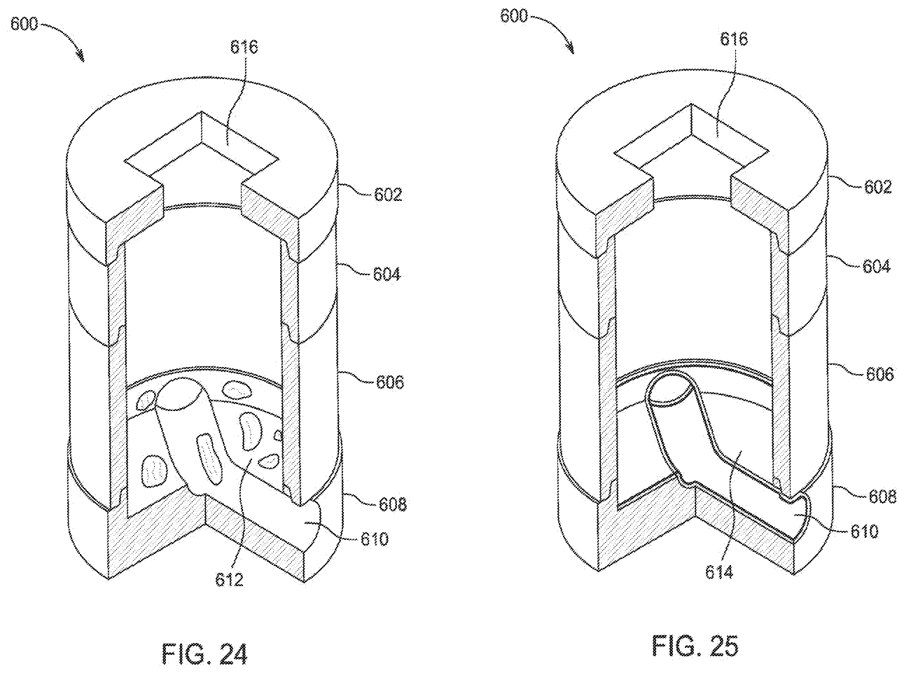

Referring now to FIG. 24, there is depicted a manhole vault assembly 600. The assembly 600 comprises a cap 602, mid-risers 604 and 606, and a base member 608. In an embodiment, the manhole vault assembly 600 is formed of concrete. The assembly 600 may be buried underground and provide access to a sewage system through an opening formed in the cap 602.

In particular, the base member 608 may include a trough 610 for directing sewage as is known to one having ordinary skill in the art. As can be observed, an inner surface 612 of the base member 608 may include damaged portions in the nature of pitting and corrosion caused by the toxic sewer gases.

A process of repairing the inner surface 612 of the base member 608 is as follows. First, the inner surface 612 is cleared of debris. Next, as illustratively shown in FIG. 21, a grinder is used to remove rough edges and loose edges on the inner surface 612. Next, a protective overlay and composite material 614 is installed onto the inner surface 612 to effectuate the repair. In an embodiment, the protective overlay material 614 is mixed in a mixer as shown in FIG. 22 and then placed onto the inner surface 612. The material 614 is then finished by using a hand trowel as illustratively shown in FIG. 23. The repaired inner surface of the base member 608 is shown in FIG. 25.

In embodiments of the present disclosure, a plastic material, such as plastic aggregate and plastic fines, may be included in Part A (or Part B) of the composition in lieu of rock aggregate and sand, or in addition to rock aggregate and sand. As used herein, “plastic aggregate” means a plastic material formed from a loosely compacted mass of fragments, pellets, granules or particles. The plastic aggregate may have a size greater than one of 0.420 mm, 0.5 mm, 0.595 mm, 0.707, mm, 0.841 mm, 1.0 mm, 2.0 mm, 3.0 mm, 4.0 mm, 5.0 mm, 6.0 mm and 7.0 mm. As used herein, “plastic fines” means very small plastic particles, including a plastic powder and pulverized plastic. The plastic fines may have a size less than one of 0.420 mm, 0.354 mm, 0.297 mm, 0.250 mm, 0.210 mm, 0.177 mm, 0.149 mm, 0.125 mm, 0.105 mm, 0.088 mm, 0.074 mm, 0.063 mm, 0.053 mm, 0.044 mm, and 0.037 mm.

It will be appreciated that plastic aggregate and plastic fines may be formed from one of virgin plastic, recycled plastic, and certified recycled plastic. It will be appreciated that the plastic fines may comprise any recycled plastic. In an embodiment, the recycled plastic fines may be created by grinding, cutting, or pulverizing recycled plastic.

As used herein, the plastic material may be sized by sieve size as is known to one of ordinary skill. As is known to one of ordinary skill, the sieve size may correspond to mesh openings as shown in the attached Appendix A. For example, plastic aggregate may have, without limitation, a mesh size between No. 4 (4.76 mm) and No. 40 (0.420 mm), or any size or size range in between shown in Appendix A. The plastic fines may have, without limitation, a sieve size of between No. 40 (0.420 mm) and No. 400 (0.037 mm), or any size or size range in between as shown in Appendix A.

In an embodiment, a compound according the present disclosure may comprise a resin, plastic aggregates, and plastic fines and optionally cenosphere. In an embodiment, a compound according the present disclosure may comprise a resin, recycled plastic aggregates, and recycled plastic fines and optionally cenosphere. In an embodiment, a compound according the present disclosure may comprise a resin and plastic aggregates but not plastic fines and optionally cenosphere. In an embodiment, a compound according the present disclosure may comprise a resin and plastic fines but not plastic aggregates and optionally cenosphere. The compounds disclosed herein may be mixed with a hardener (Part B) as is known to one of ordinary skill to cause the resin to harden into a rigid structure.

In an embodiment, a compound according the present disclosure may comprise a resin, plastic aggregates, and a plastic powder and optionally cenosphere. In an embodiment, a compound according the present disclosure may comprise a resin, recycled plastic aggregates, and recycled plastic powder and optionally cenosphere. In an embodiment, a compound according the present disclosure may comprise a resin and plastic aggregates but not plastic powder and optionally cenosphere. In an embodiment, a compound according the present disclosure may comprise a resin and plastic powder but not plastic aggregates and optionally cenosphere. The compounds disclosed herein may be mixed with a hardener (Part B) as is known to one of ordinary skill to cause the resin to harden into a rigid structure.

The compounds disclosed herein may be utilized to form structures, including, without limitation, flat work, walls, supports, beams, surface repairs, roadways, sidewalks, buildings, houses, pipes, conduits, and sewers. It will be further appreciated that the compounds formed herein may be utilized in any application that previously used concrete. In embodiments of the present disclosure, a rigid structure may comprise a resin, plastic aggregate, and plastic fines and optionally cenosphere. In embodiments of the present disclosure, a rigid structure may comprise a resin and plastic aggregate but not plastic fines and optionally cenosphere. In embodiments of the present disclosure, a rigid structure may comprise a resin and plastic fines but not plastic aggregate and optionally cenosphere. The structures may include, but are not limited to, flat work, walls, supports, beams, surface repairs, roadways, sidewalks, buildings, houses, pipes, beams, surface repairs, conduits, manholes, risers, pre-formed structures, and sewer structures.

As used herein, the term “about” means within one of 5%, 10%, 15%, 20% and 30% of the stated value, both above and below.

As can be observed in Tables 1-12, below, various formulations of a composition according to the present invention are disclosed. The compositions may be utilized to repair damaged surfaces or to create pre-formed structures.

TABLE 1

| | |
|---|---|
| Ingredient | Comprising: |

Part A

| | |
|---|---|
| Resin | 84 fluid oz |
| Plastic Aggregate or | 24 fluid oz |
| Plastic Fines | |
| Cenosphere | 12 fluid oz |

Part B

| | |
|---|---|
| Hardener | 12 fluid oz |

Mix instructions: Combine all in forced induction mixer for mixing time of 3-5 minutes.

TABLE 2

| | |
|---|---|
| Ingredient | Comprising: |

Part A

| | | |
|---|---|---|
| Resin | 24-96 | fluid oz |
| Plastic Fines | 5-100 | lbs. |
| Plastic Aggregate | 5-100 | lbs. |
| Cenosphere | 1-5 | lbs. |

Part B

| | | |
|---|---|---|
| Hardening Agent | 2.5-20 | fluid oz. |

Mix instructions: Combine all in forced induction mixer for mixing time of 3-5 minutes.

TABLE 3

| | |
|---|---|
| Ingredient | Comprising: |

Part A

| | | |
|---|---|---|
| Resin | 24-96 | fluid oz |
| Plastic Fines | 5-100 | lbs. |
| Plastic Aggregate | 5-100 | lbs. |

Part B

| | | |
|---|---|---|
| Hardening Agent | 2.5-20 | fluid oz. |

Mix instructions: Combine all in forced induction mixer for mixing time of 3-5 minutes.

TABLE 4

| | |
|---|---|
| Ingredient | Comprising: |

Part A

| | | |
|---|---|---|
| Resin | 5-96 | fluid oz |
| Plastic Aggregate or | 5-100 | lbs. |
| Plastic Fines | | |

Part B

| | | |
|---|---|---|
| Hardening Agent | 1-20 | fluid oz. |

Mix instructions: Combine all in forced induction mixer for mixing time of 3-5 minutes.

TABLE 5

| | |
|---|---|
| Ingredient | Comprising: |

Part A

| | | |
|---|---|---|
| Resin | 5-96 | fluid oz |
| Recycled Plastic Aggregate or | 5-100 | lbs. |
| Recycled Plastic Fines | | |

Part B

| | | |
|---|---|---|
| Hardening Agent | 1-20 | fluid oz. |

Mix instructions: Combine all in forced induction mixer for mixing time of 3-5 minutes.

TABLE 6

| | |
|---|---|
| Ingredient | Comprising: |

Part A

| | | |
|---|---|---|
| Resin | 5-96 | fluid oz |
| Plastic Powder | 1-100 | lbs. |

Part B

| | | |
|---|---|---|
| Hardening Agent | 1-100 | fluid oz. |

Mix instructions: Combine all in forced induction mixer for mixing time of 3-5 minutes.

TABLE 7

| | |
|---|---|
| Ingredient | Comprising: |

Part A

| | | |
|---|---|---|
| Resin | 5-96 | fluid oz |
| Plastic Aggregate and | 1-100 | lbs. |
| Plastic Powder | | |

Part B

| | | |
|---|---|---|
| Hardening Agent | 2.5-20 | fluid oz. |

Mix instructions: Combine all in forced induction mixer for mixing time of 3-5 minutes.

TABLE 8

| | |
|---|---|
| Ingredient | Comprising: |

Part A

| | | |
|---|---|---|
| Resin | 5-96 | fluid oz |
| Plastic Aggregate between No. 4 | 5-100 | lbs. |
| (4.76 mm) and No. 40 (.420 | | |
| mm) or any size or size range in | | |
| between | | |

Part B

| | | |
|---|---|---|
| Hardening Agent | 1-20 | fluid oz. |

Mix instructions: Combine all in forced induction mixer for mixing time of 3-5 minutes.

TABLE 9

| | |
|---|---|
| Ingredient | Comprising: |

Part A

| | | |
|---|---|---|
| Resin | 5-96 | fluid oz |
| Plastic Fines between No. 40 | 5-100 | lbs. |
| (.420 mm) and No. 400 (.037 | | |
| mm) or any size or size range in | | |
| between | | |
| Plastic Aggregate between No. 4 | 5-100 | lbs. |
| (4.76 mm) and No. 40 (.420 | | |
| mm) or any size or size range in | | |
| between | | |

Part B

| | | |
|---|---|---|
| Hardening Agent | 2.5-20 | fluid oz. |

Mix instructions: Combine all in forced induction mixer for mixing time of 3-5 minutes.

TABLE 10

| | |
|---|---|
| Ingredient | Comprising: |

Part A

| | | |
|---|---|---|
| Resin | 5-96 | fluid oz |
| Plastic Aggregate between No. 4 | 5-100 | lbs. |
| (4.76 mm) and No. 40 (.420 | | |
| mm) or any size or size range in | | |
| between | | |
| Plastic Powder | 5-100 | lbs. |

Part B

| | | |
|---|---|---|
| Hardening Agent | 2.5-20 | fluid oz. |

Mix instructions: Combine all in forced induction mixer for mixing time of 3-5 minutes.

TABLE 11

| | |
|---|---|
| Ingredient | Comprising: |

Part A

| | |
|---|---|
| Resin | 22 to 40 fluid oz, or about 36 |
| | fluid oz, or an effective |
| | amount |
| High Density Polyethylene | 70 to 110 fluid oz, or about |
| (HDPE) Pellets or Plastic | 88 fluid oz |
| Aggregate | |
| PVC Pulverized or | 50 to 70 fluid oz, or about 64 |
| Plastic Fines | fluid oz |
| Fly Ash | 5 to 25 fluid oz, or about 12 |
| | fluid oz |

Part B

| | |
|---|---|
| Hardening Agent | 10 fluid oz., or an effective |
| | amount |

Mix instructions: Combine all in forced induction mixer for mixing time of 3-5 minutes.

TABLE 12

| | |
|---|---|
| Ingredient | Comprising: |

Part A

| | |
|---|---|
| Resin | 10 to 30 fluid oz, 20 fluid oz, |
| | or an effective amount |
| Plastic Aggregate or | 10 to 40 fluid oz, or about 24 |
| Plastic Discs | fluid oz |
| Plastic Fines | 10 to 40 fluid oz, or about 24 |
| | fluid oz |
| Fly Ash | 10 to 40 fluid oz, or about 12 |
| | fluid oz |

Part B

| | |
|---|---|
| Hardening Agent | 4 fluid oz, or an effective |
| | amount |

Mix instructions: Combine all in forced induction mixer for mixing time of 3-5 minutes.

In an embodiment, any of the above formulations may be utilized to create pre-formed structures. These structures may include, without limitation, panels, sewage structures, pathways, countertops, roadways, runways, bridges and upright structures, including without limitation, walls, shelters, buildings, and the like. The structures may have a thickness of between one-half inch to five inches. In an embodiment, the structures may have a width and a height from one foot to ten feet. The structures may be planar, such as a panel, or include a curvature. The structures may be utilized to build storage or living accommodations, including walls and roofs. In an embodiment, the structures may be attached to the exterior of structures. The structures may be formed in molds of various shapes.

In an embodiment, the present invention is directed to a pre-formed structure having a composition comprising any of the above formulations in Tables 1-12. According to the present invention, a pre-formed structure is comprised of plastic aggregates, plastic fines, fly ash, a resin, and a hardener. According to another aspect of the present invention, a pre-formed structure is comprised of HDPE pellets, pulverized PVC, fly ash, a resin, and a hardener.

In an embodiment, the recycled plastic may be formed by the following steps:

### Step 1: Collection

The first step in the recycling process is always collecting the plastic material that is to be recycled. This step may be reliant upon businesses, restaurants, and the public to dispose of their plastic waste in the correct place. If plastic waste is disposed of in normal trash bins, it will not be recycled, so it is extremely important to separate common waste and plastic waste. Additionally, it is ideal for governments to have a recycling collection system that goes to people's houses or businesses to collect the plastic waste. If this is not possible, local collection points for plastic should be easy for the public to access. Making it easy and convenient for people to correctly dispose of plastic waste is paramount in promoting recycling.

### Step 2: Washing

Plastics must be washed before they are further processed. The goal of this step is to remove impurities and everything that is not made from plastic. Most containers and packages have labels, adhesive, or even food residue that must be removed. This non-plastic waste cannot be recycled and can cause the final product to have poor structural integrity.

### Step 3: Resizing

Resizing consists of shredding or granulating the plastic waste into small particles. This increases the surface area of the plastic, making it easier to process, reshape, and transport if needed. Additionally, it gives recycling facilities one last opportunity to remove any non-plastic waste that has made it through the first steps of processing. This is often done with metal detectors or magnets that will help remove any leftover metal in the mixture.

### Step 4: Compounding

Compounding is when the small particles are smashed and melted together into plastic shapes. In an embodiment, the small particles are smashed and melted together and then extruded through an opening. The extrusion is then sliced to form the pellets. The pellets may be disc shaped.

The two-part compositions of the present disclosure may include a part A and a part B. Parts A and B are typically mixed on-site just prior to installation. Mixing parts A and B causes a reaction which starts the curing process. Part A is referred to herein as the resin and part B is referred to as the hardening agent. The two-part composition is applied to a damaged surface while it is still a liquid. Once applied over a surface, the composite material cures until hard. In an embodiment, the resin utilized herein may be a polymer resin.

It will be appreciated that embodiments of the present invention provide an improved concrete repair technology that is able to repair foundations, road, curbs, speed bumps, parking lots, concrete pads, driveways, sidewalks, and other concrete structures. It will be further appreciated that repairs using the formulations disclosed herein may be up to four times stronger than traditional concrete. It will be further appreciated that embodiments of the present disclosure may reduce repair time to 30 minutes and significantly reduce repair costs as compared to traditional repair methods. Moreover, embodiments of the present disclosure allow repairs to be performed year-round—in both hot and cold weather.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A method of repairing a damaged surface comprising:
preparing the damaged surface; and
applying a liquid composition on the damaged surface;
wherein the composition comprises resin and plastic aggregate.

2. The method of claim 1, wherein the composition further comprises plastic fines.

3. The method of claim 1, wherein the composition further comprises a hardener.

4. The method of claim 1, wherein the plastic aggregate is disc shaped.

5. The method of claim 1, wherein the plastic aggregate is formed from one or more of virgin plastic and recycled plastic.

6. The method of claim 1, wherein a size of the plastic aggregate is less than 5.0 mm.

7. The method of claim 1, wherein a size of the plastic aggregate is greater than 1.0 mm.

8. The method of claim 1, wherein the composition further comprises fly ash.

9. A composition comprising:
plastic aggregate;
resin, and
a hardener.

10. The composition of claim 9, further comprising pulverized plastic.

11. The composition of claim 9, wherein the composition is a liquid.

12. The composition of claim 10, further comprising fly ash.

13. The method of claim 1, wherein a size of the plastic aggregate is less than 5.0 mm.

14. The method of claim 1, wherein a size of the plastic aggregate is greater than 1.0 mm.

15. A pre-formed structure having a composition comprising:
plastic aggregate;
a resin; and
a hardener.

16. The structure of claim 15, wherein the composition further comprises plastic fines.

17. The structure of claim 16, wherein the composition further comprises fly ash.

18. The structure of claim 15, wherein the structure is a panel.

19. The structure of claim 18. wherein the panel has a thickness of about one inch.

20. The structure of claim 15. wherein the plastic aggregate has a size less than 5.0 mm.
